(19) United States
(12) Patent Application Publication
(10) Pub. No.: US 2015/0196970 A1
(43) Pub. Date: Jul. 16, 2015

(54) DEVICES AND METHODS FOR COMMUNICATING IN A WELDING SYSTEM

(71) Applicant: Illinois Tool Works Inc., Glenview, IL (US)

(72) Inventor: MARC L DENIS, Lena, WI (US)

(73) Assignee: Illinois Tool Works Inc., Glenview, IL (US)

(21) Appl. No.: 14/152,309

(22) Filed: Jan. 10, 2014

(51) Int. Cl. B23K 9/10

(52) U.S. Cl. CPC B23K 9/10; B23K 9/1006

(57) ABSTRACT

A welding device includes a welding power input configured to receive welding power and data via a welding power cable. The welding power is combined with the data. Moreover, the data is encoded using Orthogonal Frequency Division Multiplexing (OFDM). The welding device also includes control circuitry configured to receive the OFDM encoded data and to decode the OFDM encoded data.

### BACKGROUND

The invention relates generally to welding applications and, more particularly, to devices and methods for communicating in a welding system.

Welding is a process that has increasingly become utilized in various industries and applications. Such processes may be automated in certain contexts, although a large number of applications continue to exist for manual welding operations. In both cases, such welding operations rely on a variety of types of equipment to ensure the supply of welding consumables (e.g., wire feed, shielding gas, etc.) is provided to the weld in appropriate amounts at the desired time.

In certain welding systems, data and welding power may be provided together over a single conductor. In such welding systems, data may be properly communicated only while a welding operation is not occurring. However, during a welding operation, the data that is provided with the welding power may become noisy, thereby interfering with communication of data during the welding operation. In some systems, inductors have been used to limit interference in the communication of data during a welding operation. Unfortunately, using inductors to enable communication of data during the welding operation may be expensive. There is a need, therefore, for improved techniques allowing for low cost communication of data combined with power during a welding operation.

### BRIEF DESCRIPTION

In one embodiment, a welding device includes a welding power input configured to receive welding power and data via a welding power cable. The welding power is combined with the data. Moreover, the data is encoded using Orthogonal Frequency Division Multiplexing (OFDM). The welding device also includes control circuitry configured to receive the OFDM encoded data and to decode the OFDM encoded data.

In another embodiment, a welding device includes a welding power output configured to provide welding power and data via a welding power cable. The welding power is combined with the data. Moreover, the data is encoded using Orthogonal Frequency Division Multiplexing (OFDM). Furthermore, the welding device includes control circuitry configured to encode the OFDM data and to provide the encoded OFDM data to another device.

In another embodiment, a welding device includes a welding power interface configured to receive input data combined with welding power via a welding power cable and to provide output data combined with the welding power via the welding power cable. The input data and the output data are encoded using Orthogonal Frequency Division Multiplexing (OFDM). The welding device also includes control circuitry configured to decode the input OFDM data, to encode the output OFDM data, and to provide the encoded output OFDM data to another device.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an embodiment of a welding system including a welding power supply and a welding device that communicates data together with welding power, in accordance with aspects of the present disclosure;

FIG. 2 is a cross-sectional view of an embodiment of a welding power cable of FIG. 1, in accordance with aspects of the present disclosure;

FIG. 3 is a flow chart of an embodiment of a method for communicating data in a welding system, in accordance with aspects of the present disclosure; and

FIG. 4 is a flow chart of an embodiment of another method for communicating data in a welding system, in accordance with aspects of the present disclosure.

### DETAILED DESCRIPTION

One or more specific embodiments of the present disclosure will be described below. These described embodiments are only examples of the present disclosure. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

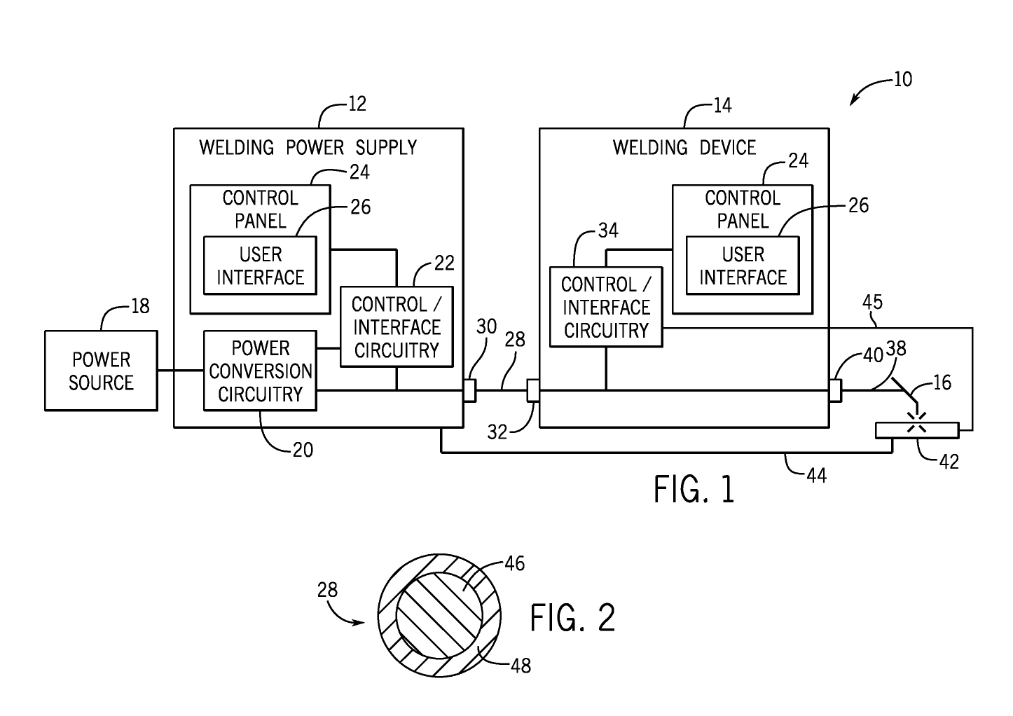

Turning now to the figures, FIG. 1 is a block diagram of an embodiment of a welding system 10 including a welding power supply 12 and a welding device 14 that communicates data together with welding power. The welding system 10 powers, controls, and provides supplies to a welding operation. The welding power supply 12 provides welding power that is used by a torch 16 to perform the welding operation. The welding power supply 12 receives input power from a power source 18 (e.g., from the AC power grid, an engine/generator set, a battery, or a combination thereof), conditions the input power, and provides an output power to one or more welding devices in accordance with demands of the system 10. The input power may be supplied from an offsite location (i.e., the input power may originate from a wall outlet). The welding power source 12 includes power conversion circuitry 20 that may include circuit elements such as transformers, rectifiers, switches, and so forth, capable of converting the AC input power to a DCEP or DCEN output as dictated by the demands of the system 10.

In some embodiments, the power conversion circuitry 20 may be configured to convert the input power to both weld and auxiliary power outputs. However, in other embodiments, the power conversion circuitry 20 may be adapted to convert input power only to a weld power output, and a separate auxiliary converter may be provided to convert primary power to auxiliary power. Still further, in some embodiments, the welding power supply 12 may be adapted to receive a converted auxiliary power output directly from a wall outlet. Indeed, any suitable power conversion system or mechanism may be employed by the welding power supply 12 to generate and supply both weld and auxiliary power.

The welding power supply 12 includes control/interface circuitry 22. The control/interface circuitry 22 controls the operations of the welding power supply 12 and may receive input from a control panel 24 having a user interface 26 through which a user may choose a process, and input desired parameters (e.g., voltages, currents, particular pulsed or non-pulsed welding regimes, and so forth). The control/interface circuitry 22 may also be configured to receive and process a plurality of inputs regarding the performance and demands of the system 10. Furthermore, the control/interface circuitry 22 may provide data (e.g., using power line communication) relating to the operation of the welding power supply 12 to other welding devices (e.g., the welding device 14) in the system 10. The control/interface circuitry 22 may include volatile or non-volatile memory, such as ROM, RAM, magnetic storage memory, optical storage memory, or a combination thereof. In addition, a variety of control parameters may be stored in the memory along with code configured to provide a specific output (e.g., initiate wire feed, enable gas flow, etc.) during operation.

Data and welding power are provided from the welding power supply 12 to the welding device 14 via a welding power cable 28. Specifically, the data is carried by the welding power using power line communication (e.g., the welding power and the data are provided on the same electrical conductor, the data is provided using a modulated signal carried by the welding power, the data and the welding power are combined together). Such power line communication is described, for example, in U.S. Pat. No. 7,180,029 B2, U.S. application Ser. No. 11/276,288, U.S. patent application Ser. No. 11/609,871, and U.S. patent application Ser. No. 11/625,357, which are hereby incorporated into the present disclosure by reference in their entirety. Accordingly, data and welding power flow through an output 30 of the welding power supply 12. Furthermore, data and welding power flow through an input 32 of the welding device 14.

The data may be encoded on the welding power using Orthogonal Frequency Division Multiplexing (OFDM) to facilitate communication between two welding devices during a welding operation. For example, the control/interface circuitry 22 may be configured to encode the data using OFDM and to facilitate combining the OFDM encoded data with the welding power for being output via the output 30. Furthermore, the control/interface circuitry 22 may be configured to decode OFDM encoded data received via the output 30 (or received via another connection). In some embodiments, the control/interface circuitry 22 may include components such as part number TMS320F28609 sold by Texas Instruments of Dallas, Tex. As may be appreciated, the OFDM encoded data may incorporate multiple modulated signals. The signals may be modulated using at least one of bi-phase shift keying (BPSK), quadrature phase shift keying (QPSK), offset quadrature phase shift keying (O-BPSK), 8-value phase shift keying (8PSK), 8-value quadrature amplitude modulation (8-QAM), and 16-value quadrature amplitude modulation (16-QAM). The OFDM may use any suitable frequency band, such as a band between approximately 10 kHz and 500 kHz, a band between approximately 1.6 MHz and 30 MHz, and so forth.

The welding device 14 may be any suitable welding device. For example, the welding device 14 may be a pendant (e.g., not a wire feeder), a remote control, a wire feeder, and so forth. In other embodiments, the welding device 14 may be replaced by an induction heating device. Moreover, in some embodiments, the welding device 14 may be the welding torch 16. The welding device 14 includes control/interface circuitry 34 that controls the operations of the welding device 14 and may receive input from the control panel 24 having the user interface 26 through which a user may choose a process, and input desired parameters (e.g., voltages, currents, particular pulsed or non-pulsed welding regimes, and so forth).

The control/interface circuitry 34 may also be configured to receive and process a plurality of inputs regarding the performance and demands of the system 10. Furthermore, the control/interface circuitry 34 may provide data (e.g., using power line communication) relating to the operation of the welding device 14 to other welding devices (e.g., the welding power supply 12) in the system 10. The control/interface circuitry 34 may include volatile or non-volatile memory, such as ROM, RAM, magnetic storage memory, optical storage memory, or a combination thereof. In addition, a variety of control parameters may be stored in the memory along with code configured to provide a specific output (e.g., initiate wire feed, enable gas flow, etc.) during operation.

The control/interface circuitry 34 may be configured to decode the OFDM encoded data received with the welding power via the input 32 (or received with the welding power via another connection). As may be appreciated, the input 32 may be configured to send and/or receive welding power combined with data to and/or from a welding power supply, a wire feeder, a pendant, a welding torch, and so forth. Furthermore, the control/interface circuitry 34 may be configured to encode data using OFDM and provide the data together with welding power via the input 32 (or provide the data with the welding power via another connection).

A weld cable 38 provides welding power to the torch 16. As illustrated, the weld cable 38 is coupled to an output 40 of the welding device 14. In certain embodiments, the weld cable 38 may also provide shielding gas to a welding operation. A work piece 42 is also coupled to the welding power supply 12 via a work cable 44 to enable a welding arc to be formed by providing a return path for welding power. Furthermore, as illustrated, a work sense cable 45 couples the control/interface circuitry 34 of the welding device 14 to the work piece 42 to provide a complete circuit for powering the welding device 14.

FIG. 2 is a cross-sectional view of an embodiment of the welding power cable 28 of FIG. 1. As illustrated, the welding power cable 28 includes a single electrical conductor 46 that carries welding power and data together (e.g., via power line communication). As may be appreciated, the electrical conductor 46 may be a single wire or a bundle of non-insulated wires (e.g., twisted wires). An insulator 48 surrounds and insulates the electrical conductor 46.

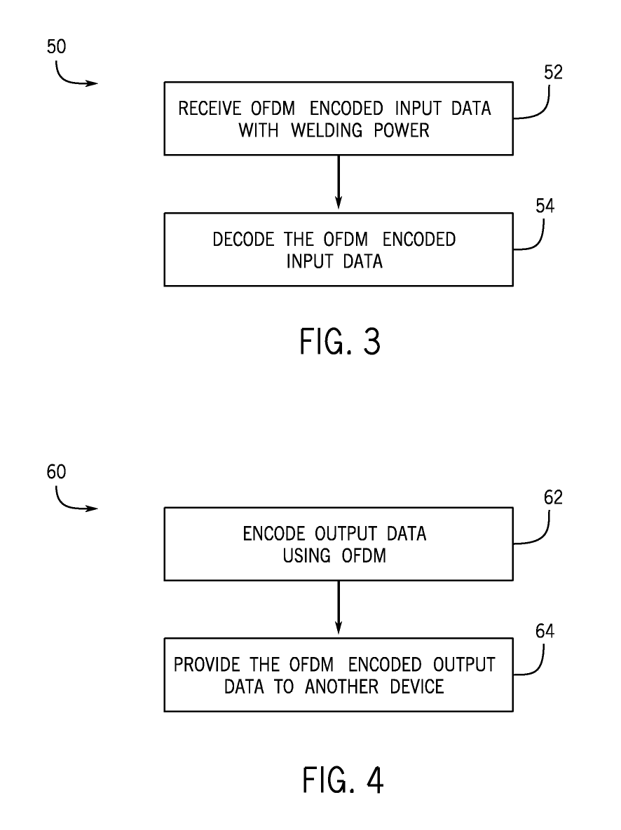

FIG. 3 is a flow chart of an embodiment of a method 50 for communicating data in a welding system. A welding device (e.g., welding power supply, wire feeder, pendant, welding torch, etc.) receives OFDM encoded input data that is combined with welding power (e.g., carried via a single electrical conductor) (block 52). Control circuitry (e.g., the control/interface circuitry 22 or 34) of the welding device decodes the OFDM encoded input data for use by the welding device (block 54).

FIG. 4 is a flow chart of an embodiment of another method 60 for communicating data in a welding system. Control circuitry (e.g., the control/interface circuitry 22 or 34) of a welding device (e.g., welding power supply, wire feeder, pendant, welding torch, etc.) encodes data using OFDM (block 62). The welding device provides the OFDM encoded output data to another device using a single electrical conductor (block 64).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding device comprising:
a welding power input configured to receive welding power and data via a welding power cable, wherein the welding power is combined with the data, and wherein the data is encoded using Orthogonal Frequency Division Multiplexing (OFDM); and
control circuitry configured to receive the OFDM encoded data and to decode the OFDM encoded data.

2. The welding device of claim 1, wherein the welding power input is configured to receive welding power and data from a welding power supply.

3. The welding device of claim 1, wherein the welding power input is configured to receive welding power and data from a wire feeder.

4. The welding device of claim 1, wherein the welding power input is configured to receive welding power and data from a pendant.

5. The welding device of claim 1, wherein the welding device comprises a wire feeder.

6. The welding device of claim 1, wherein the welding device comprises a welding torch.

7. The welding device of claim 1, wherein the welding device comprises a pendant.

8. The welding device of claim 1, wherein the welding power cable comprises a single electrical conductor that carries the welding power and data together.

9. The welding device of claim 1, wherein the OFDM uses a frequency band of between approximately 10 kHz and 500 kHz.

10. The welding device of claim 1, wherein the OFDM uses a plurality of modulated signals.

11. The welding device of claim 10, wherein the modulated signals are modulated using at least one of bi-phase shift keying (BPSK), quadrature phase shift keying (QPSK), offset quadrature phase shift keying (O-BPSK), 8-value phase shift keying (8PSK), 8-value quadrature amplitude modulation (8-QAM), and 16-value quadrature amplitude modulation (16-QAM).

12. A welding device comprising:
a welding power output configured to provide welding power and data via a welding power cable, wherein the welding power is combined with the data, and wherein the data is encoded using Orthogonal Frequency Division Multiplexing (OFDM); and
control circuitry configured to encode the OFDM data and to provide the encoded OFDM data to another device.

13. The welding device of claim 12, wherein the welding device comprises a welding power supply.

14. The welding device of claim 12, wherein the OFDM uses a plurality of modulated signals.

15. The welding device of claim 14, wherein the modulated signals are modulated using at least one of bi-phase shift keying (BPSK), quadrature phase shift keying (QPSK), offset quadrature phase shift keying (O-BPSK), 8-value phase shift keying (8PSK), 8-value quadrature amplitude modulation (8-QAM), and 16-value quadrature amplitude modulation (16-QAM).

16. The welding device of claim 12, wherein the welding power cable comprises a single electrical conductor that carries the welding power and data together.

17. A welding device comprising:
a welding power interface configured to receive input data combined with welding power via a welding power cable and to provide output data combined with the welding power via the welding power cable, wherein the input data and the output data are encoded using Orthogonal Frequency Division Multiplexing (OFDM); and
control circuitry configured to decode the input OFDM data, to encode the output OFDM data, and to provide the encoded output OFDM data to another device.

18. The welding device of claim 17, wherein the welding device comprises a welding power supply.

19. The welding device of claim 17, wherein the welding device comprises a wire feeder.

20. The welding device of claim 17, wherein the welding power cable comprises a single electrical conductor that carries the welding power and data together.
